(19) United States
(12) Patent Application Publication
(10) Pub. No.: US 2023/0191489 A1
(43) Pub. Date: Jun. 22, 2023

(54) METHOD FOR PRODUCING AN ALUMINIUM ALLOY PART

(71) Applicant: C-TEC Constellium Technology Center, Voreppe (FR)

(72) Inventors: Bechir CHEHAB, Voiron (FR); Ravi SHAHANI, Voreppe (FR)

(21) Appl. No.: 17/995,968

(22) PCT Filed: May 10, 2021
(86) PCT No.: PCT/FR2021/050802

§ 371 Date: Oct. 11, 2022

(30) Foreign Application Priority Data
May 13, 2020 (FR) FR2004725

(51) Int. Cl. B22F 10/28; B22F 1/05; B22F 1/142; B22F 1/065; B22F 1/00

(52) U.S. Cl. CPC B22F 10/28; B22F 1/05; B22F 1/09; B22F 1/065; B22F 1/142; B33Y 10/00

(57) ABSTRACT

The invention relates to a method for producing a part, comprising the production of successive solid metallic layers (201...20n), each layer being produced by depositing a metal (25) called filler metal, said method being characterized in that the part has a specific grain structure.

The invention also relates to a part obtained by means of this method and an alternative method.

The alloy used in the additive manufacturing method of the invention makes it possible to obtain parts with exceptional properties.

### TECHNICAL FIELD

The technical field of the invention is a method for producing an aluminum alloy part, using an additive manufacturing technique.

### PRIOR ART

Since the 1980s, additive manufacturing techniques have been developed. They consist of forming a part by adding material, which is the opposite of machining techniques, which are aimed at removing material. Previously confined to prototyping, additive manufacturing is now operational for manufacturing mass-produced industrial products, including metallic parts.

The term “additive manufacturing” is defined, as per the French standard XP E67-001, as a set of methods for producing, layer upon layer, by adding material, a physical object from a digital object. The standard ASTM F2792 (January 2012) also defines additive manufacturing. Various additive manufacturing methods are also defined in the standard ISO/ASTM 17296-1. The use of additive manufacturing to produce an aluminum part, with a low porosity, was described in the document WO2015/006447. The application of successive layers is generally carried out by applying a so-called filler material, then melting or sintering the filler material using an energy source such as a laser beam, electron beam, plasma torch or electric arc. Regardless of the additive manufacturing method applied, the thickness of each layer added is of the order of some tens or hundreds of microns.

A means of additive manufacturing is melting or sintering a filler material taking the form of a powder. This may consist of laser melting or sintering using an energy beam.

Selective laser sintering techniques are known (selective laser sintering, SLS or direct metal laser sintering, DMLS), wherein a layer of metal powder or metal alloy is applied on the part to be manufactured and is sintered selectively according to the digital model with thermal energy from a laser beam. A further type of metal formation method comprises selective laser melting (SLM) or electron beam melting (EBM), wherein the thermal energy supplied by a laser or a targeted electron beam is used to selectively melt (instead of sinter) the metallic powder so that it melts as it cools and solidifies.

Laser melting deposition (LMD) is also known, wherein the powder is sprayed and melted by a laser beam simultaneously.

Patent application WO2016/209652 describes a method for producing a high mechanical strength aluminum comprising: preparing an atomized aluminum powder having one or more desired approximate powder sizes and an approximate morphology; sintering the powder to form a product by additive manufacturing; solution heat treatment; quenching; and aging of the aluminum manufactured with an additive process.

There is a growing demand for high-strength aluminum alloys usable at high temperatures for the SLM application. The 4xxx alloys (essentially Al10SiMg, Al7SiMg and Al12Si) are the most mature aluminum alloys for the SLM application. These alloys offer a very good suitability for the SLM method but suffer from limited mechanical properties.

Scalmalloy® (DE102007018123A1) developed by APWorks offers (with a post-manufacturing thermal treatment of 4h at 325° C.) good mechanical properties at ambient temperature. However, this solution suffers from a high cost in powder form linked with the high scandium content (^{~} 0.7% Sc) thereof and the need for a specific atomization process. This solution also suffers from poor mechanical properties at high temperatures, for example at temperatures greater than 150° C.

Addalloy® developed by NanoAl (WO201800935A1) is an Al Mg Zr alloy. This alloy suffers from limited mechanical properties at high temperatures.

The 8009 alloy (Al Fe V Si), developed by Honeywell (US201313801662) offers good mechanical properties in the as-manufactured temper both at ambient temperature and at high temperatures up to 350° C. However, the 8009 alloy suffers from processability problems (risk of cracking), probably associated with the substantial hardness thereof in the as-manufactured temper.

Some studies have been conducted relating to the impact of the construction slab temperature on sensitivity to cracking. Mention can be made in particular of US20190039183, which recommends a temperature of 350 to 500° C. for some 2xxx, 5xxx, 6xxx or 7xxx type aluminum alloys. Mention can also be made of the publication entitled “Investigation on reducing distortion by preheating during manufacture of aluminum components using selective laser melting” (Buchbinder et al., Journal of Laser Applications, 26, 2014), which recommends a temperature of 150 to 250° C. for AlSi10Mg type aluminum alloys.

The mechanical properties of aluminum parts obtained by additive manufacturing are dependent on the alloy forming the filler metal, and more specifically on the composition thereof, the parameters of the additive manufacturing method as well as the thermal treatments applied. The inventors determined certain characteristics which, used in an additive manufacturing method, make it possible to obtain parts having remarkable characteristics. In particular, the parts obtained according to the present invention have enhanced characteristics with respect to the prior art, particularly in terms of yield strength at 200° C. and cracking sensitivity during the SLM method.

### DESCRIPTION OF THE INVENTION

The inventors discovered that better control of the granular structure through a well-judged choice of composition and method parameters, and in particularly control of the manufacturing temperature (for example of the manufacturing slab), can help:
eliminate cracking sensitivity problems;
maintain a good hardening capacity (difference in mechanical strength at ambient temperature between the as-manufactured temper and the temper after a thermal treatment at approximately 400° C.); and
provide good mechanical performances at ambient temperature and at high temperatures.

The invention firstly relates to a method for producing a part, comprising the production of successive solid metallic layers, which are superimposed on each other, each layer describing a pattern defined using a digital model, each layer being produced by depositing a metal, called filler metal, the filler metal being subjected to a supply of energy so as to become molten and to constitute, upon solidifying, said layer, wherein the filler metal takes the form of a powder, the exposure of which to an energy beam results in a melting followed by a solidification, so as to form a solid layer,
the method being characterized in that the part is produced at a temperature from 25 to 150° C.;
the method also being characterized in that the part has a grain structure such that the surface fraction of the equiaxial grains each having an area less than 2.16 µm² is less than 44%, preferably less than 40%, preferably less than 36%; and a grain structure such that the surface fraction of columnar grains is greater than or equal to 22%, preferably greater than or equal to 25%, preferably greater than or equal to 30%;
the method also being characterized in that the filler metal (25) is an aluminum alloy comprising at least the following alloy elements:
   Zr, in a mass fraction greater than or equal to 0.30%, preferably 0.30-2.50%, preferably 0.40-2.00%, more preferably 0.40-1.80%, even more preferably 0.50-1.60%, even more preferably 0.60-1.50%, even more preferably 0.70-1.40%, even more preferably 0.80-1.20% in total;
   Sc, in a mass fraction less than 0.30%, preferably less than 0.20%, preferably less than 0.10%, more preferably less than 0.05%;
   Mg, in a mass fraction less than 2.00%, preferably less than 1.00%, preferably less than 0.50%, more preferably less than 0.30%, even more preferably less than 0.10%, even more preferably less than 0.05%;
   Zn, in a mass fraction less than 2.00%, preferably less than 1.00%, preferably less than 0.50%, more preferably less than 0.30%, even more preferably less than 0.10%, even more preferably less than 0.05%;
   optionally at least one element selected from: Ni, Mn, Cr and/or Cu, in a mass fraction of 0.50 to 7.00%, preferably of 1.00 to 6.00% each; preferably, in a mass fraction less than 25.00%, preferably less than 20.00%, more preferably less than 15.00% in total;
   optionally at least one element selected from: Hf, Ti, Er, W, Nb, Ta, Y, Yb, Nd, Ce, Co, Mo, Lu, Tm, V and/or mischmetal, in a mass fraction less than or equal to 5.00%, preferably less than or equal to 3% each, and less than or equal to 15.00%, preferably less than or equal to 12%, more preferably less than or equal to 5% in total;
   optionally at least one element selected from: Si, La, Sr, Ba, Sb, Bi, Ca, P, B, In and/or Sn, in a mass fraction less than or equal to 1.00%, preferably less than or equal to 0.5%, preferably less than or equal to 0.3%, more preferably less than or equal to 0.1%, even more preferably less than or equal to 700 ppm each, and less than or equal to 2.00%, preferably less than or equal to 1% in total;
   optionally Fe, in a mass fraction of 0.50 to 7.00%, preferably of 1.00 to 6.00% according to a first alternative embodiment, or in a mass fraction less than or equal to 1.00%, preferably less than or equal to 0.5%, preferably less than or equal to 0.3%, more preferably less than or equal to 0.1%, even more preferably less than or equal to 700 ppm according to a second alternative embodiment;
   optionally at least one element selected from: Ag in a mass fraction of 0.06 to 1.00% and/or Li in a mass fraction of 0.06 to 1.00%;
   optionally impurities in a mass fraction less than 0.05% each (i.e., 500 ppm) and less than 0.15% in total;
   the remainder being aluminum.

It is known by a person skilled in the art that other elements have equivalent effects to those of Zr. Mention can be made of Ti, V, Sc, Hf, Er, Tm, Yb or Lu in particular. Thus, according to an alternative embodiment of the first subject matter of the present invention, Zr could be replaced partially by at least one element selected from: Ti, V, Sc, Hf, Er, Tm, Yb and Lu, preferably up to 90% of the mass fraction of Zr.

The invention thus secondly relates to a method for producing a part, comprising the production of successive solid metallic layers (20₁...20ₙ), which are superimposed on each other, each layer describing a pattern defined using a digital model (M), each layer being produced by depositing a metal (25), called filler metal, the filler metal being subjected to a supply of energy so as to become molten and to constitute, upon solidifying, said layer, wherein the filler metal takes the form of a powder (25), the exposure of which to an energy beam (32) results in a melting followed by a solidification, so as to form a solid layer (20₁...20ₙ),
the method being characterized in that the part is produced at a temperature from 25 to 150° C.; the method also being characterized in that the part has a grain structure such that the surface fraction of the equiaxial grains each having an area less than 2.16 µm² is less than 44%, preferably less than 40%, preferably less than 36%; and a grain structure such that the surface fraction of columnar grains is greater than or equal to 22%, preferably greater than or equal to 25%, preferably greater than or equal to 30%;
the method also being characterized in that the filler metal (25) is an aluminum alloy comprising at least the following alloy elements:
   Zr and at least one element selected from: Ti, V, Sc, Hf, Er, Tm, Yb and Lu, in a mass fraction greater than or equal to 0.30%, preferably 0.30-2.5%, preferably 0.40-2.0%, more preferably 0.40-1.80%, even more preferably 0.50-1.60%, even more preferably 0.60-1.50%, even more preferably 0.70-1.40%, even more preferably 0.80-1.20% in total, in the knowledge that Zr represents from 10 to less than 100% of the percentage ranges given hereinabove;
   Mg, in a mass fraction less than 2.00%, preferably less than 1.00%, preferably less than 0.50%, more preferably less than 0.30%, even more preferably less than 0.10%, even more preferably less than 0.05%;
   Zn, in a mass fraction less than 2.00%, preferably less than 1.00%, preferably less than 0.50%, more preferably less than 0.30%, even more preferably less than 0.10%, even more preferably less than 0.05%;
   optionally at least one element selected from: Ni, Mn, Cr and/or Cu, in a mass fraction of 0.50 to 7.00%, preferably of 1.00 to 6.00% each; preferably, in a mass fraction less than 25.00%, preferably less than 20.00%, more preferably less than 15.00% in total;
   optionally at least one element selected from: W, Nb, Ta, Y, Nd, Ce, Co, Mo and/or mischmetal, in a mass fraction less than or equal to 5.00%, preferably less than or equal to 3% each, and less than or equal to 15.00%, preferably less than or equal to 12%, more preferably less than or equal to 5% in total;
   optionally at least one element selected from: Si, La, Sr, Ba, Sb, Bi, Ca, P, B, In and/or Sn, in a mass fraction less than or equal to 1.00%, preferably less than or equal to 0.5%, preferably less than or equal to 0.3%, more preferably less than or equal to 0.1%, even more preferably less than or equal to 700 ppm each, and less than or equal to 2.00%, preferably less than or equal to 1% in total;
   optionally Fe, in a mass fraction of 0.50 to 7.00%, preferably of 1.00 to 6.00% according to a first alternative embodiment, or in a mass fraction less than or equal to 1.00%, preferably less than or equal to 0.5%, preferably less than or equal to 0.3%, more preferably less than or equal to 0.1%, even more preferably less than or equal to 700 ppm according to a second alternative embodiment;
   optionally at least one element selected from: Ag in a mass fraction of 0.06 to 1.00% and/or Li in a mass fraction of 0.06 to 1.00%;
   optionally impurities in a mass fraction less than 0.05% each (i.e., 500 ppm) and less than 0.15% in total;
   the remainder being aluminum.

Preferably, the alloy according to the present invention, in particular according to the first and second subject matter of the invention, comprises a mass fraction of at least 80%, more preferably of at least 85% of aluminum.

The melting of the powder can be partial or complete. Preferably, from 50 to 100% of the exposed powder becomes molten, more preferably from 80 to 100%.

Each layer can particularly describe a pattern defined on the basis of a digital model.

Without being bound by theory, the alloys according to the invention seem to be particularly advantageous for having a good compromise between cracking sensitivity and mechanical strength, particularly cold and high-temperature tensile strength, for example at 200° C.

As shown in the examples hereinafter, the structure of the grains and the temperature at which the part is produced seem to be predominant influencing factors on the cracking sensitivity of the aluminum alloy.

Preferably, in particular according to the first and second subject matter of the invention, the part is produced at a temperature from 50 to 130° C., more preferably from 50 to 110° C., even more preferably from 80 to 110° C., even more preferably from 80 to 105° C.

Preferably, in particular according to the first and second subject matter of the invention, the aluminum alloy comprises:
Zr, in a mass fraction of 0.50 to 3.00%, preferably of 0.50 to 2.50%, preferably of 0.60 to 1.40%, more preferably of 0.70 to 1.30%, even more preferably of 0.80 to 1.20%, even more preferably of 0.85 to 1.15%; even more preferably of 0.90 to 1.10%;
Mn, in a mass fraction of 1.00 to 7.00%, preferably of 1.00 to 6.00%, preferably of 2.00 to 5.00%; more preferably of 3.00 to 5.00%, even more preferably of 3.50 to 4.50%;
Ni, in a mass fraction of 1.00 to 6.00%, preferably of 1.00 to 5.00%, preferably of 2.00 to 4.00%, more preferably of 2.50 to 3.50%;
optionally Fe, in a mass fraction less than or equal to 1.00%, preferably less than or equal to 0.50%, preferably less than or equal to 0.30%; and preferably greater than or equal to 0.05, preferably greater than or equal to 0.10%;
optionally Si, in a mass fraction less than or equal to 1.00%, preferably less than or equal to 0.50%;
optionally Cu, in a mass fraction of 1.00 to 5.00%, preferably of 1.00 to 3.00%, preferably of 1.50 to 2.50%.

The elements Hf, Ti, Er, W, Nb, Ta, Y, Yb, Nd, Ce, Co, Mo, Lu, Tm, V and/or mischmetal can cause the formation of dispersoids or fine intermetallic phases, making it possible to increase the hardness of the material obtained. In a manner known to a person skilled in the art, the composition of the mischmetal is generally from about 45 to 50% cerium, 25% lanthanum, 15 to 20% neodymium and 5 % praseodymium.

According to an embodiment, the addition of La, Bi, Mg, Er, Yb, Y, Sc and/or Zn is avoided, the preferred mass fraction of each of these elements then being less than 0.05%, and preferably less than 0.01%.

According to a further embodiment, the addition of Fe and/or Si is avoided. However, it is known by a person skilled in the art that these two elements are generally present in common aluminum alloys at contents as defined hereinabove. The contents as described hereinabove can therefore also correspond to impurity contents for Fe and Si.

The elements Ag and Li can act upon the resistance of the material by hardening precipitation or by the effect thereof on the properties of the solid solution.

Optionally, in particular according to the first and second subject matter of the invention, the alloy can also comprise at least one element to refine the grains, for example AlTiC or AlTiB2 (for example in AT5B or AT3B form), according to a quantity less than or equal to 50 kg/ton, preferably less than or equal to 20 kg/ton, even more preferably less than or equal to 12 kg/ton each, and less than or equal to 50 kg/ton, preferably less than or equal to 20 kg/ton in total.

The invention thirdly relates to an alternative method which also makes it possible to solve the cracking sensitivity problem while retaining good mechanical hot and cold tensile performances, for example at 200° C., without requiring a solution heat treatment/quenching. It consists of a method for producing a part comprising the production of successive solid metallic layers (2o₁···20ₙ), which are superimposed on each other, each layer describing a pattern defined using a digital model (M), each layer being produced by depositing a metal (25), called filler metal, the filler metal being subjected to a supply of energy so as to become molten and to constitute, upon solidifying, said layer, wherein the filler metal takes the form of a powder (25), the exposure of which to an energy beam (32) results in a melting followed by a solidification, so as to form a solid layer (20₁...20ₙ),
the method being characterized in that the filler metal (25) is an aluminum alloy comprising at least the following alloy elements:
   Zr, in a mass fraction greater than or equal to 0.30%, preferably 0.30-2.50%, preferably 0.40-2.00%, more preferably 0.40-1.80%, even more preferably 0.50-1.60%, even more preferably 0.60-1.50%, even more preferably 0.70-1.40%, even more preferably 0.80-1.20%;
   Sc, in a mass fraction less than 0.30 %, preferably less than 0.20%, preferably less than 0.10%, more preferably less than 0.05%;
   Mg, in a mass fraction less than 2.00%, preferably less than 1.00%, preferably less than 0.50%, more preferably less than 0.30%, even more preferably less than 0.10%, even more preferably less than 0.05%;
   Zn, in a mass fraction less than 2.00%, preferably less than 1.00%, preferably less than 0.50%, more preferably less than 0.30%, even more preferably less than 0.10%, even more preferably less than 0.05%;
   optionally at least one element selected from: Ni, Mn, Cr and/or Cu, in a mass fraction of 0.50 to 7.00%, preferably of 1.00 to 6.00% each; preferably, in a mass fraction less than 25.00%, preferably less than 20.00%, more preferably less than 15.00% in total;
   optionally at least one element selected from: Hf, Ti, Er, W, Nb, Ta, Y, Yb, Nd, Ce, Co, Mo, Lu, Tm, V and/or mischmetal, in a mass fraction less than or equal to 5.00%, preferably less than or equal to 3% each, and less than or equal to 15.00%, preferably less than or equal to 12%, more preferably less than or equal to 5% in total;
   optionally at least one element selected from: Si, La, Sr, Ba, Sb, Bi, Ca, P, B, In and/or Sn, in a mass fraction less than or equal to 1.00%, preferably less than or equal to 0.5%, preferably less than or equal to 0.3%, more preferably less than or equal to 0.1%, even more preferably less than or equal to 700 ppm each, and less than or equal to 2.00%, preferably less than or equal to 1% in total;
   optionally Fe, in a mass fraction of 0.50 to 7.00%, preferably of 1.00 to 6.00% according to a first alternative embodiment, or in a mass fraction less than or equal to 1.00%, preferably less than or equal to 0.5%, preferably less than or equal to 0.3%, more preferably less than or equal to 0.1%, even more preferably less than or equal to 700 ppm according to a second alternative embodiment;
   optionally at least one element selected from: Ag in a mass fraction of 0.06 to 1.00% and/or Li in a mass fraction of 0.06 to 1.00%;
   optionally impurities in a mass fraction less than 0.05% each (i.e., 500 ppm) and less than 0.15% in total;
   the remainder being aluminum;
the method being also characterized in that the part is produced at a temperature from more than 250 to less than 350° C., preferably from 280 to 330° C.

As stated above, it is known by a person skilled in the art that other elements have equivalent effects to those of Zr. Mention can be made of Ti, V, Sc, Hf, Er, Tm, Yb or Lu in particular. Thus, according to an alternative embodiment of the third subject matter of the present invention, Zr could be replaced partially by at least one element selected from: Ti, V, Sc, Hf, Er, Tm, Yb and Lu, preferably up to 90% of the mass fraction of Zr.

The invention thus fourthly relates to a method for producing a part comprising the production of successive solid metallic layers (20₁...20ₙ), which are superimposed on each other, each layer describing a pattern defined using a digital model (M), each layer being produced by depositing a metal (25), called filler metal, the filler metal being subjected to a supply of energy so as to become molten and to constitute, upon solidifying, said layer, wherein the filler metal takes the form of a powder (25), the exposure of which to an energy beam (32) results in a melting followed by a solidification, so as to form a solid layer (20₁...20ₙ), the method being characterized in that the filler metal (25) is an aluminum alloy comprising at least the following alloy elements:
Zr and at least one element selected from: Ti, V, Sc, Hf, Er, Tm, Yb and Lu, in a mass fraction greater than or equal to 0.30%, preferably 0.30-2.50 %, preferably 0.40-2.00 %, more preferably 0.40-1.80%, even more preferably 0.50-1.60%, even more preferably 0.60-1.50%, even more preferably 0.70-1.40%, even more preferably 0.80-1.20% in total, in the knowledge that Zr represents from 10 to less than 100% of the percentage ranges given hereinabove;
Mg, in a mass fraction less than 2.00%, preferably less than 1.00%, preferably less than 0.50%, more preferably less than 0.30%, even more preferably less than 0.10%, even more preferably less than 0.05%;
Zn, in a mass fraction less than 2.00%, preferably less than 1.00%, preferably less than 0.50%, more preferably less than 0.30%, even more preferably less than 0.10%, even more preferably less than 0.05%;
optionally at least one element selected from: Ni, Mn, Cr and/or Cu, in a mass fraction of 0.50 to 7.00%, preferably of 1.00 to 6.00% each; preferably, in a mass fraction less than 25.00%, preferably less than 20.00%, more preferably less than 15.00% in total;
optionally at least one element selected from: W, Nb, Ta, Y, Nd, Ce, Co, Mo and/or mischmetal, in a mass fraction less than or equal to 5.00%, preferably less than or equal to 3% each, and less than or equal to 15.00%, preferably less than or equal to 12%, more preferably less than or equal to 5% in total;
optionally at least one element selected from: Si, La, Sr, Ba, Sb, Bi, Ca, P, B, In and/or Sn, in a mass fraction less than or equal to 1.00%, preferably less than or equal to 0.5%, preferably less than or equal to 0.3%, more preferably less than or equal to 0.1%, even more preferably less than or equal to 700 ppm each, and less than or equal to 2.00%, preferably less than or equal to 1% in total;
optionally Fe, in a mass fraction of 0.50 to 7.00%, preferably of 1.00 to 6.00% according to a first alternative embodiment, or in a mass fraction less than or equal to 1.00%, preferably less than or equal to 0.5%, preferably less than or equal to 0.3%, more preferably less than or equal to 0.1%, even more preferably less than or equal to 700 ppm according to a second alternative embodiment;
optionally at least one element selected from: Ag in a mass fraction of 0.06 to 1.00% and/or Li in a mass fraction of 0.06 to 1.00%;
optionally impurities in a mass fraction less than 0.05% each (i.e., 500 ppm) and less than 0.15% in total;
the remainder being aluminum;
the method being also characterized in that the part is produced at a temperature from more than 250 to less than 350° C., preferably from 280 to 330° C.

According to the present invention, the part is produced either at a temperature of 25 to 150° C., preferably of 50 to 130° C., more preferably of 50 to 110° C., even more preferably of 80 to 110° C., even more preferably of 80 to 105° C., or at a temperature of more than 250 to less than 350° C., preferably of 280 to 330° C. These two selections of optimized temperatures are described in more detail in the examples hereinafter. There are several means for heating the chamber for producing a part (and therefore the powder bed) with additive manufacturing. Mention can be made for example of a heating construction slab, or heating with a laser, by induction, by heating lamps or by heating elements which can be placed below and/or inside the construction slab, and/or around the powder bed.

According to an embodiment, the method can be a construction method with a high application rate. The application rate can for example be greater than 4 mm³/s, preferably greater than 6 mm³/s, more preferably greater than 7 mm³/s. The application rate is calculated as the product of the scanning speed (in mm/s), the vector deviation (in mm) and the layer thickness (in mm).

According to an embodiment, the method can use a laser, and optionally several lasers.

According to an embodiment, the method can include, following the production of the layers:
a thermal treatment typically at a temperature of at least 100° C. and at most 500° C., preferably of 300 to 450° C.; and/or
a hot isostatic compression (HIC).

The thermal treatment can particularly enable stress relieving of the residual stress and/or an additional precipitation of hardening phases.

The HIC treatment can particularly make it possible to enhance the elongation properties and the fatigue properties. The hot isostatic compression can be carried out before, after or instead of the thermal treatment.

Advantageously, the hot isostatic compression is carried out at a temperature of 250° C. to 550° C. and preferably of 300° C. to 450° C., at a pressure of 500 to 3000 bar and for a duration of 0.5 to 10 hours.

According to a further embodiment, adapted to structural hardening alloys, a solution heat treatment followed by a quenching and an aging of the part formed and/or a hot isostatic compression can be carried out. The hot isostatic compression can in this case advantageously replace the solution heat treatment. However, the method according to the invention is advantageous as it needs preferably no solution heat treatment followed by quenching. The solution heat treatment can have a harmful effect on the mechanical strength in certain cases by contributing to growth of dispersoids or fine intermetallic phases. Moreover, on complex-shaped parts, the quenching operation could result in a distortion of the parts, which would limit the primary advantage of the use of additive manufacturing, which is that of obtaining parts directly in the final or almost final form thereof.

According to an embodiment, the method according to the present invention further optionally includes a machining treatment, and/or a chemical, electrochemical or mechanical surface treatment, and/or a tribofinishing. These treatments can be carried out particularly to reduce the roughness and/or enhance the corrosion resistance and/or enhance the resistance to fatigue crack initiation.

Optionally, it is possible to carry out a mechanical deformation of the part, for example after additive manufacturing and/or before the thermal treatment.

Optionally, it is possible to carry out a joining operation with one or more other parts, with known joining methods. Mention can be made for example by way of joining operation of:
bolting, riveting or other mechanical joining methods;
fusion welding;
friction welding;
brazing.

The invention fifthly relates to a metallic part, obtained with a method according to the first or second subject matter of the invention, characterized in that it has a grain structure such that the surface fraction of the equiaxial grains each having an area less than 2.16 µm² is less than 44%, preferably less than 40%, preferably less than 36%; and such that the surface fraction of columnar grains is greater than or equal to 22%, preferably greater than or equal to 25%, more preferably greater than or equal to 30%.

The invention sixthly relates to a powder comprising, preferably consisting of, an aluminum alloy comprising at least the following alloy elements:
Zr, in a mass fraction of 0.30-1.40 %, preferably of 0.40-1.40%, more preferably of 0.50-1.40%, even more preferably of 0.60-1.40%, even more preferably of 0.70-1.40%, even more preferably of 0.80-1.20%;
Sc, in a mass fraction less than 0.30%, preferably less than 0.20%, preferably less than 0.10%, more preferably less than 0.05%;
Mg, in a mass fraction less than 2.00%, preferably less than 1.00%, preferably less than 0.50%, more preferably less than 0.30%, even more preferably less than 0.10%, even more preferably less than 0.05%;
Zn, in a mass fraction less than 2.00%, preferably less than 1.00%, preferably less than 0.50%, more preferably less than 0.30%, even more preferably less than 0.10%, even more preferably less than 0.05%;
optionally at least one element selected from: Ni, Mn, Cr and/or Cu, in a mass fraction of 0.50 to 7.00%, preferably of 1.00 to 6.00% each; preferably, in a mass fraction less than 25.00%, preferably less than 20.00%, more preferably less than 15.00% in total;
optionally at least one element selected from: Hf, Ti, Er, W, Nb, Ta, Y, Yb, Nd, Ce, Co, Mo, Lu, Tm, V and/or mischmetal, in a mass fraction less than or equal to 5.00%, preferably less than or equal to 3% each, and less than or equal to 15.00%, preferably less than or equal to 12%, more preferably less than or equal to 5% in total;
optionally at least one element selected from: Si, La, Sr, Ba, Sb, Bi, Ca, P, B, In and/or Sn, in a mass fraction less than or equal to 1.00%, preferably less than or equal to 0.5%, preferably less than or equal to 0.3%, more preferably less than or equal to 0.1%, even more preferably less than or equal to 700 ppm each, and less than or equal to 2.00%, preferably less than or equal to 1% in total;
optionally Fe, in a mass fraction of 0.50 to 7.00%, preferably of 1.00 to 6.00% according to a first alternative embodiment, or in a mass fraction less than or equal to 1.00%, preferably less than or equal to 0.5%, preferably less than or equal to 0.3%, more preferably less than or equal to 0.1%, even more preferably less than or equal to 700 ppm according to a second alternative embodiment;
optionally at least one element selected from: Ag in a mass fraction of 0.06 to 1.00% and/or Li in a mass fraction of 0.06 to 1.00%;
optionally impurities in a mass fraction less than 0.05% each (i.e., 500 ppm) and less than 0.15% in total;
the remainder being aluminum.

As stated above, it is known by a person skilled in the art that other elements have equivalent effects to those of Zr. Mention can be made of Ti, V, Sc, Hf, Er, Tm, Yb or Lu in particular. Thus, according to an alternative embodiment of the aluminum alloy of the powder according to the present invention, Zr could be replaced partially by at least one element selected from: Ti, V, Sc, Hf, Er, Tm, Yb and Lu, preferably up to 90% of the mass fraction of Zr.

The invention thus seventhly relates to a powder comprising, preferably consisting of, an aluminum alloy which comprises at least the following alloy elements:
Zr and at least one element selected from: Ti, V, Sc, Hf, Er, Tm, Yb and Lu, in a mass fraction of 0.30-1.40%, preferably of 0.40-1.40%, more preferably of 0.50-1.40%, even more preferably of 0.60-1.40%, even more preferably of 0.70-1.40%, even more preferably of 0.80-1.20% in total, in the knowledge that Zr represents from 10 to less than 100% of the percentage ranges given hereinabove;
Mg, in a mass fraction less than 2.00%, preferably less than 1.00%, preferably less than 0.50%, more preferably less than 0.30%, even more preferably less than 0.10%, even more preferably less than 0.05%;
Zn, in a mass fraction less than 2.00%, preferably less than 1.00%, preferably less than 0.50%, more preferably less than 0.30%, even more preferably less than 0.10%, even more preferably less than 0.05%;
optionally at least one element selected from: Ni, Mn, Cr and/or Cu, in a mass fraction of 0.50 to 7.00%, preferably of 1.00 to 6.00% each; preferably, in a mass fraction less than 25.00%, preferably less than 20.00%, more preferably less than 15.00% in total;
optionally at least one element selected from: W, Nb, Ta, Y, Nd, Ce, Co, Mo and/or mischmetal, in a mass fraction less than or equal to 5.00 %, preferably less than or equal to 3% each, and less than or equal to 15.00%, preferably less than or equal to 12 %, more preferably less than or equal to 5% in total;
optionally at least one element selected from: Si, La, Sr, Ba, Sb, Bi, Ca, P, B, In and/or Sn, in a mass fraction less than or equal to 1.00%, preferably less than or equal to 0.5%, preferably less than or equal to 0.3%, more preferably less than or equal to 0.1%, even more preferably less than or equal to 700 ppm each, and less than or equal to 2.00%, preferably less than or equal to 1% in total;
optionally Fe, in a mass fraction of 0.50 to 7.00%, preferably of 1.00 to 6.00% according to a first alternative embodiment, or in a mass fraction less than or equal to 1.00%, preferably less than or equal to 0.5%, preferably less than or equal to 0.3%, more preferably less than or equal to 0.1%, even more preferably less than or equal to 700 ppm according to a second alternative embodiment;
optionally at least one element selected from: Ag in a mass fraction of 0.06 to 1.00% and/or Li in a mass fraction of 0.06 to 1.00%;
optionally impurities in a mass fraction less than 0.05% each (i.e., 500 ppm) and less than 0.15% in total;
the remainder being aluminum.

Preferably, the alloy of the powder and the alternative method according to the present invention comprises a mass fraction of at least 80%, more preferably of at least 85% aluminum. Preferably, the aluminum alloy of the powder (sixth and seventh subject matter of the invention) and the alternative method (third and fourth subject matter of the invention) according to the present invention comprises:
Zr, in a mass fraction of 0.50 to 3.00%, preferably of 0.50 to 2.50%, preferably of 0.60 to 1.40%, more preferably of 0.70 to 1.30%, even more preferably of 0.80 to 1.20%, even more preferably of 0.85 to 1.15%; even more preferably of 0.90 to 1.10%;
Mn, in a mass fraction of 1.00 to 7.00%, preferably of 1.00 to 6.00%, preferably of 2.00 to 5.00%; more preferably of 3.00 to 5.00%, even more preferably of 3.50 to 4.50%;
Ni, in a mass fraction of 1.00 to 6.00%, preferably of 1.00 to 5.00%, preferably of 2.00 to 4.00%, more preferably of 2.50 to 3.50%;
optionally Fe, in a mass fraction less than or equal to 1.00%, preferably less than or equal to 0.50%, preferably less than or equal to 0.30%; and preferably greater than or equal to 0.05, preferably greater than or equal to 0.10%;
optionally Si, in a mass fraction less than or equal to 1.00%, preferably less than or equal to 0.50%;
optionally Cu, in a mass fraction of 1.00 to 5.00%, preferably of 1.00 to 3.00%, preferably of 1.50 to 2.50%.

The aluminum alloy of the powder and the alternative method according to the present invention can also optionally comprise at least one element to refine the grains, for example AlTiC or AlTiB2 (for example in AT5B or AT3B form), according to a quantity less than or equal to 50 kg/ton, preferably less than or equal to 20 kg/ton, even more preferably less than or equal to 12 kg/ton each, and less than or equal to 50 kg/ton, preferably less than or equal to 20 kg/ton in total.

Preferably, the addition of La, Bi, Mg, Er, Yb, Y, Sc and/or Zn is avoided, the preferred mass fraction of each of these elements then being less than 0.05 %, and preferably less than 0.01%. According to a further embodiment, the addition of Fe and/or Si is avoided. However, it is known by a person skilled in the art that these two elements are generally present in common aluminum alloys at contents as defined hereinabove. The contents as described hereinabove can therefore also correspond to impurity contents for Fe and Si.

Further advantages and features will emerge more clearly from the following description and from the non-limiting examples, represented in the figures listed below.

### FIGURES

FIG. 1 is a diagram illustrating an SLM, or EBM type additive manufacturing method.

FIG. 2 shows a cracking test specimen as used in the example. Reference 1 corresponds to the face used for metallographic observations, reference 2 to the critical cracking measurement zone, reference 3 to the manufacturing direction.

FIG. 3 is a test specimen geometry used to perform tensile tests, as used in the examples.

### DETAILED DESCRIPTION OF THE INVENTION

In the description, unless specified otherwise:
aluminum alloys are designated according to the nomenclature established by the Aluminum Association;
the chemical element contents are designated as a % and represent mass fractions.

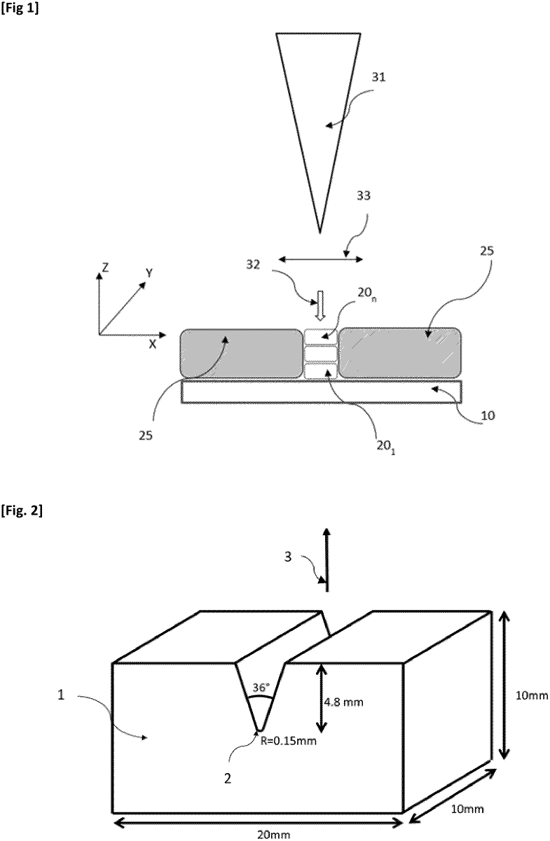

FIG. 1 generally describes an embodiment, wherein the additive manufacturing method according to the invention is used. According to this method, the filler material 25 is presented in the form of an alloy powder according to the invention. An energy source, for example a laser source or an electron source 31, emits an energy beam for example a laser beam or an electron beam 32. The energy source is coupled with the filler material by an optical or electromagnetic lens system 33, the movement of the beam thus being capable of being determined according to a digital model M. The energy beam 32 follows a movement along the longitudinal plane XY, describing a pattern dependent on the digital model M. The powder 25 is deposited on a construction slab 10. The interaction of the energy beam 32 with the powder 25 induces selective melting thereof, followed by a solidification, resulting in the formation of a layer 20ᵢ...20ₙ. When a layer has been formed, it is coated with filler metal powder 25 and a further layer is formed, superimposed on the layer previously produced. The thickness of the powder forming a layer can for example be from 10 to 200 µm. This additive manufacturing mode is typically known as selective laser melting (SLM) when the energy beam is a laser beam, the method being in this case advantageously executed at atmospheric pressure, and as electron beam melting (EBM) when the energy beam is an electron beam, the method being in this case advantageously executed at reduced pressure, typically less than 0.01 bar and preferably less than 0.1 mbar.

In a further embodiment, the layer is obtained by selective laser sintering (SLS) or direct metal laser sintering (DMLS), the layer of alloy powder according to the invention being selectively sintered according to the digital model selected with thermal energy supplied by a laser beam. In a further embodiment not described by FIG. 1, the powder is sprayed and melted simultaneously by a generally laser beam. This method is known as laser melting deposition.

Further methods can be used, particularly those known as Direct Energy Deposition (DED), Direct Metal Deposition (DMD), Direct Laser Deposition (DLD), Laser Deposition Technology (LDT), Laser Metal Deposition (LMD), Laser Engineering Net Shaping (LENS), Laser Cladding Technology (LCT), or Laser Freeform Manufacturing Technology (LFMT).

In an embodiment, the method according to the invention is used for producing a hybrid part comprising a portion obtained using conventional rolling and/or extrusion and/or casting and/or forging methods optionally followed by machining and a rigidly connected portion obtained by additive manufacturing. This embodiment can also be suitable for repairing parts obtained using conventional methods.

It is also possible, in an embodiment of the invention, to use the method according to the invention for repairing parts obtained by additive manufacturing.

Following the formation of the successive layers, an unwrought part or part in an as-manufactured temper is obtained.

According to an embodiment, the yield strength measured at ambient temperature of the part in the as-manufactured temper according to the present invention is less than 450 MPa, preferably less than 400 MPa, more preferably from 200 to 400 MPa, and even more preferably from 200 to 350 MPa.

According to an embodiment, the yield strength measured at ambient temperature of a part according to the present invention after a thermal treatment not including a solution heat treatment or quenching operation is greater than the yield strength of the same part in the as-manufactured temper. Preferably, the yield strength measured at ambient temperature of a part according to the present invention after a thermal treatment such as that cited hereinabove is greater than 350 MPa, preferably greater than 400 MPa.

According to an embodiment, the yield strength of the part measured at high temperatures remains high. Indeed, the yield strength measured at 200° C., for a part in the as-manufactured temper or after stress relieving treatment at least of 350° C., remains greater than 50%, preferably greater than 60%, of the yield strength measured at ambient temperature.

The powder used according to the present invention can have at least one of the following features:
mean particle size from 3 to 100 µm, preferably from 5 to 25 µm, or from 20 to 60 µm. The values given signify that at least 80% of the particles have a mean size within the specified range;
spherical shape. The sphericity of a powder can for example be determined using a morphogranulometer;
good castability. The castability of a powder can for example be determined as per the standard ASTM B213 or the standard ISO 4490:2018. According to the standard ISO 4490:2018, the flow time is preferably less than 50 s;
low porosity, preferably from 0 to 5%, more preferably from 0 to 2%, even more preferably from 0 to 1% by volume. The porosity can particularly be determined by scanning electron microscopy or by helium pycnometry (see the standard ASTM B923);
absence or small quantity (less than 10%, preferably less than 5% by volume) of small, so-called satellite, particles (1 to 20% of the mean size of the powder), which adhere to the larger particles.

The powder used according to the present invention can be obtained with conventional atomization methods using an alloy according to the invention in liquid or solid form or, alternatively, the powder can be obtained by mixing primary powders before the exposure to the energy beam, the different compositions of the primary powders having an average composition corresponding to the composition of the alloy according to the invention.

It is also possible to add infusible, non-soluble particles, for example oxides or particles of titanium dibromide TiB₂ or particles of titanium carbide TiC, in the bath before atomizing the powder and/or during the deposition of the powder and/or during the mixing of the primary powders. These particles can serve to refine the microstructure. They can also serve to harden the alloy if they are of nanometric size. These particles can be present according to a volume fraction less than 30%, preferably less than 20%, more preferably less than 10%.

The powder used according to the present invention can be obtained for example by gas jet atomization, plasma atomization, water jet atomization, ultrasonic atomization, centrifugal atomization, electrolysis and spheroidization, or grinding and spheroidization.

Preferably, the powder according to the present invention is obtained by gas jet atomization. The gas jet atomization method starts with casting a molten metal through a nozzle. The molten metal is then reached by inert gas jets, such as nitrogen or argon, optionally accompanied by other gases, and atomized into very small droplets which are cooled and solidified by falling inside an atomization tower. The powders are then collected in a can. The gas jet atomization method has the advantage of producing a powder having a spherical shape, unlike water jet atomization which produces a powder having an irregular shape. A further advantage of gas jet atomization is a good powder density, particularly thanks to the spherical shape and the particle size distribution. A further advantage of this method is a good reproducibility of the particle size distribution.

After the manufacture thereof, the powder according to the present invention can be oven-dried, particularly in order to reduce the moisture thereof. The powder can also be packaged and stored between the manufacture and use thereof.

The powder according to the present invention can particularly be used in the following applications:
Selective Laser Sintering or SLS;
Direct Metal Laser Sintering or DMLS;
Selective Heat Sintering or SHS;
Selective Laser Melting or SLM;
Electron Beam Melting or EBM;
Laser Melting Deposition;
Direct Energy Deposition or DED;
Direct Metal Deposition or DMD;
Direct Laser Deposition or DLD;
Laser Deposition Technology or LDT;
Laser Engineering Net Shaping or LENS;
Laser Cladding Technology or LCT;
Laser Freeform Manufacturing Technology or LFMT;
Laser Metal Deposition or LMD;
Cold Spray Consolidation or CSC;
Additive Friction Stir or AFS;
Field Assisted Sintering Technology, FAST or spark plasma sintering); or
Inertia Rotary Friction Welding or IRFW.

The invention will be described in more detail in the example hereinafter.

The invention is not limited to the embodiments described in the description above or in the examples hereinafter, and can vary widely within the scope of the invention as defined by the claims attached to the present description.

### EXAMPLES

### Example 1

A first study was conducted on an alloy A having the composition indicated in Table 1 hereinafter, determined by ICP (Inductively Coupled Plasma) as a mass %. This alloy was obtained in SLM method powder form using gas jet atomization (Ar). The particle size was essentially from 3 µm to 100 µm, D10 was approximately 35 µm, D50 approximately 48 µm and D90 approximately 67 µm.

TABLE 1

| Alloy | %Mn | %Ni | %Cu | %Zr |
|---|---|---|---|---|
| A | 3.52 | 2.93 | 1.99 | 1.53 |

Using an EOS290 type SLM machine (supplier EOS), cracking test specimens were produced with a view to studying the sensitivity of this alloy to cracking.

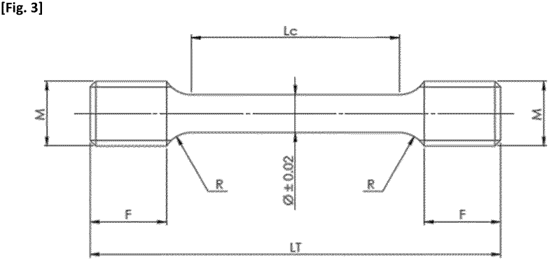

These test specimens, which are represented in FIG. 2, have a specific geometry having a critical site prone to crack initiation. This critical site has a radius of curvature R. When printing these test specimens, the main laser parameters used were as follows: laser power of 370 W; scanning speed of 1400 mm/s; vector deviation of 0.11 mm; layer thickness of 60 µm. The EOSM290 machine used makes it possible to heat the construction slab with heating elements up to a temperature of 200° C. Cracking test specimens were printed using this machine with a plateau temperature of 50° C., 80° C., 100°, and 200° C. In all cases, the test specimens underwent a post-manufacture stress relief treatment of 4 hours at 300° C.

After manufacture, the test specimens were mechanically polished to 1 µm on the face shown in FIG. 2 (Reference 1). The total length of the crack present on the critical initiation site of the test specimens was measured using an optical microscope with a magnification factor of X50. The results are summarized in Table 2 hereinafter.

TABLE 2

| Alloy | Slab heating temperature (°C) | Cracking on sample (µm) |
|---|---|---|
| A | 200 | 1660 |
| A | 120 | 1184 |
| A | 100 | 490 |
| A | 80 | <50 |
| A | 50 | <50 |

The results of this first study show that a reduction of the slab temperature between 200° C. and 50° C. is advantageous for reducing the cracking sensitivity of alloy A. This result runs counter to several studies from the literature (see the prior art section hereinabove in the present description) which demonstrate a beneficial effect of preheating the construction slab above 150° C., or even above 350° C. on cracking during the SLM method.

It is worth noting that, in this example, the inventors deliberately placed themselves in conditions conducive to promoting cracking, in order to be able to effectively compare the impact of the construction slab temperature on the sensitivity to cracking. The use of test specimens with less complex shapes would not have made it possible to be sufficiently discriminatory. Therefore, the present example merely serves to demonstrate the impact of the construction slab temperature on the sensitivity to cracking.

Within the scope of additional tests, not shown here, with compositions according to the invention on another SLM machine which has a heating slab up to a temperature of 500° C., the inventors demonstrated that a slab temperature of 250 to 350° C., and preferably of 280 to 330° C., also made it possible to prevent cracking on the cracking test specimens, without degrading the mechanical performances at ambient temperature and at 200° C. Surprisingly, despite the increase in the slab temperature, there was no decrease in the mechanical properties in the unwrought temper or after a thermal treatment. Without being bound by theory, it seems that, under these conditions, the alloys according to the present invention make it possible to retain a good ability to trap the addition elements in solid solution, and especially Zr. An additional increase in the slab temperature, for example to 400° C. or to 500° C., seems to make it possible to reduce the solidification rate during the SLM method and thus limit the trapping of Zr in solid solution, which seems to degrade the mechanical properties in the unwrought temper, and the ability of the alloys for additional hardness during post-manufacture heat treatments, for example at 400° C. In conclusion, the slab temperature range which seems to maximize cracking sensitivity is located between 150° C. and 250° C.

Thus, the temperature ranges of the construction slab recommended according to the present invention are either from 25 to 150° C., preferably from 50 to 130° C., more preferably from 80 to 110° C., even more preferably from 80 to 105° C., i.e., at a temperature from more than 250 to less than 350° C., preferably from 280 to 330° C.

### Example 2

A study was conducted in order to determine the influence of the temperature of the construction slab on the mechanical tensile characteristics at ambient temperature and at 200° C. of parts obtained by additive manufacturing. For this, alloy A from example 1 was used.

Using an EOSM290 type SLM machine (supplier EOS), vertical cylindrical samples relative to the direction of construction (Z direction) were produced in order to determine the mechanical characteristics of the alloy. These samples have a diameter of 11 mm and a height of 46 mm. When printing these samples, the main laser parameters used were as follows: laser power of 370 W; scanning speed of 1400 mm/s; vector deviation of 0.11 mm; layer thickness of 60 µm. Two construction slab temperatures were tested: 100° C. and 200° C.

In all cases, the samples underwent a post-manufacture stress relief treatment of 4 hours at 300° C.

The cylindrical samples were machined to obtain tensile test specimens with the following characteristics, as described in Table 3 hereinafter and FIG. 3:

TABLE 3

| Test specimen type | ø (mm) | M (mm) | LT (mm) | R (mm) | Lc (mm) | F (mm) |
|---|---|---|---|---|---|---|
| TOR 4 | 4 | 8 | 45 | 3 | 22 | 8.7 |

In Table 3 hereinabove and FIG. 3, ø represents the diameter of the central portion of the test specimen; M the width of the two ends of the test specimen; LT the total length of the test specimen; R the radius of curvature between the central portion and the ends of the test specimen; Lc the length of the central portion of the test specimen and F the length of the two ends of the test specimen.

After machining, some test specimens underwent a thermal treatment of 1 h at 400° C. The thermal treatment of 1 h at 400° C. makes it possible to simulate a post-manufacture hot isostatic compression operation or a long-term aging at an operating temperature between 100° C. and 300° C. of the final part.

The test specimens then underwent a tensile test at ambient temperature (25° C.) as per the standard NF EN ISO 6892-1 (2009-10) and at high temperature (200° C.) as per the standard NF EN ISO 6892-2 (2018). The main results are summarized in Table 4 hereinafter.

TABLE 4

| Alloy | Construction slab temperature (°C) | Duration of thermal treatment at 400° C. (h) | Tensile test temperature (°C) | RP02 (MPa) |
|---|---|---|---|---|
| A | 100 | 0 | 25 | 372 |
| A | 100 | 0 | 200 | 284 |
| A | 100 | 1 | 25 | 477 |
| A | 100 | 1 | 200 | 257 |
| A | 200 | 0 | 25 | 406 |
| A | 200 | 0 | 200 | 271 |
| A | 200 | 1 | 25 | 459 |
| A | 200 | 1 | 200 | 246 |

Of the two construction slab temperatures tested (100° C. and 200° C.), the temperature of 100° C. seems to be advantageous. Indeed, a construction slab temperature of 100° C. made it possible to obtain better mechanical properties for all the conditions tested except for the tensile test conducted at 25° C. on an as-stress relieved temper (with no post-manufacture thermal treatment at 400° C.).

However, the softer as-stress relieved temper in the tensile test at 25° C. is also advantageous because it involves lower levels of residual stress during the production of the part with SLM, and lesser final part distortion problems.

For the two construction slab temperatures tested, the post-manufacture thermal treatment of 1 h at 400° C. enabled a significant increase in the yield strength at 25° C. in relation to the as-stress relieved temper (with no post-manufacture thermal treatment at 400° C.). This type of post-manufacture treatment is advantageous for maximizing the yield strength for applications of parts working at ambient temperature or at a temperature less than 150° C.

Conversely, for the two construction slab temperatures tested, the post-manufacture thermal treatment of 1 h at 400° C. induced a decrease in the yield strength at 200° C. of approximately 26 MPa in relation to the as-stress relieved temper (with no post-manufacture thermal treatment at 400° C.). An as-stress relieved temper seems to be advantageous for so-called “high-temperature” applications, i.e., for parts working at approximately 200° C., or more generally at temperatures greater than 150° C.

### Example 3

Cracking test specimens, identical to those of example 1, were produced from alloy A described in example 1 and alloys F and H described in Table 5 hereinafter. Alloys F and H were obtained in SLM method powder form using gas jet atomization (Argon). The particle size was essentially from 3 µm to 100 µm, D10 was from 9 to 30 µm, D50 from 25 to 44 µm and D90 from 51 to 64 µm.

TABLE 5

| Alloy | %Mn | %Ni | %Cu | %Zr |
|---|---|---|---|---|
| F | 3.77 | 2.77 | 1.90 | 1.02 |
| H | 3.07 | 4.13 | 1.94 | 0.63 |

The laser parameters used were the same as those in example 1: laser power of 370 W; scanning speed of 1400 mm/s; vector deviation of 0.11 mm; layer thickness of 60 µm. The construction slab was heated to 200° C. for alloy A and to 100° C. for alloys F and H. The test specimens underwent a post-manufacture stress relief treatment of 4 hours at 300° C.

As in example 1, the total length of the crack present at the critical initiation site of the cracking test specimens was determined for each alloy.

Characterizations of the granular structure were also carried out on all the samples with EBSD (Electron Back Scattered Diffraction) using an EDAX camera and OIM (Orientation Imaging Microscopy) software. These characterizations were carried out using a ZEISS Ultra 55 type FEG-SEM with an energy of 15 keV on a 500 µm x 500 µm field with a 0.5 µm pitch.

Prior to EBSD characterization, all the samples underwent conventional mechanical polishing (emery paper with lubrication with water followed by polishing cloths with diamond suspension) to 1 µm, followed by vibratory polishing with an amplitude of 30% for 6 h, using a 50% dilution of SPM (colloidal silica gel) in water as a lubricant.

The total surface fraction of grains which each have an area greater than a given threshold value was calculated for all the samples. Several threshold values were used: 2.16 µm², 3.24 µm², 6.48 µm², 8.64 µm² and 10.8 µm². Th results are shown in Table 6 hereinafter.

TABLE 6

| Alloy | Slab heating temp (°C) | Crack length (µm) | Total surface fraction (%) | | | | |
|---|---|---|---|---|---|---|---|
| | | | Grains > 2.16 µm² | Grains > 3.24 µm² | Grains > 6.48 µm² | Grains > 8.64 µm² | Grains > 10.8 µm² |
| A | 200 | 1660 | 56 | 48 | 27 | 22 | 19 |
| F | 100 | 0 | 68 | 62 | 45 | 38.5 | 34 |
| H | 100 | 0 | 88 | 80 | 65 | 59 | 55 |

The results of Table 6 hereinabove show that a total surface fraction of grains, each having an area greater than 2.16 µm², greater than 56%, preferably greater than 60%, and more preferably greater than 64% is advantageous for completely eliminating cracking during the SLM method. In other words, a total surface fraction of fine grains, each having an area greater than 2.16 µm², less than 44%, preferably less than 40%, and more preferably less than 36% is advantageous for preventing cracking during the SLM method. These fine grains had an equiaxial structure.

The results of Table 6 hereinabove show that a total surface fraction of grains, each having an area greater than 3.24 µm², greater than 48 %, preferably greater than 52%, and more preferably greater than 57% is advantageous for completely eliminating cracking during the SLM method.

The results of Table 6 hereinabove show that a total surface fraction of grains, each having an area greater than 6.48 µm², greater than 27%, preferably greater than 35%, and more preferably greater than 40% is advantageous for completely eliminating cracking during the SLM method. The results of Table 6 hereinabove show that a total surface fraction of grains, each having an area greater than 8.64 µm², greater than 22%, preferably greater than 27%, and more preferably greater than 33%, is advantageous for completely eliminating cracking during the SLM method. The results of Table 6 hereinabove show that a total surface fraction of grains, each having an area greater than 10.8 µm², greater than 19%, preferably greater than 25%, and more preferably greater than 30% is advantageous for completely eliminating cracking during the SLM method. The surface fraction of columnar grains measured is 22% for alloy A, 39% for alloy F and 60% for alloy H. This measurement was made with OIM software, considering the grains having a length / width ratio greater than or equal to 3. This result showed that a granular structure with a fraction of columnar grains greater than or equal to 22%, preferably greater than or equal to 25%, and even more preferably greater than or equal to 30% is advantageous for eliminating cracking during the SLM method.

Columnar grains in the absence of cracks generally have a length less than 500 µm, preferably less than 300 µm, more preferably less than 200 µm, even more preferably less than 150 µm. Columnar grains generally have a width less than 150 µm, preferably less than 100 µm, preferably less than 50 µm, more preferably less than 30 µm, even more preferably less than 20 µm.

The granular structure to be sought to limit cracking therefore seems to be a structure with a surface fraction of columnar grains greater than 22% and a surface fraction of fine equiaxial grains each with an area < 2.16 µm² less than 44%.

This result runs counter to the prior art on the development of aluminum alloys for the SLM application, which strongly encourages seeking a fine and completely equiaxial structure for eliminating solidification cracks in aluminum alloys during SLM production. This equiaxial structure can particularly be obtained by introducing different types of nuclei or nucleating agents, as illustrated for example in the following patent applications and publication: US2020024700A1; US2018161874A1; Martin et al: September 2017 vol 549 NATURE 365 “3D printing of high-strength aluminium alloys”.

In additional tests, the inventors demonstrated that the presence of Mg can induce microcracking on samples with a mostly columnar structure. The micro-cracks propagate at the grain boundaries parallel with the columnar grains. The presence of Mg can also result in smoke formation during the SLM method, with a risk of Laser method instability. Thus, in an alternative embodiment of the present invention, the Mg content is preferably less than 2%, preferably less than 1%, and more preferably less than 0.05%.

1. A method for producing a part, comprising production of successive solid metallic layers, which are superimposed on each other, each layer describing a pattern defined using a digital model, each layer being produced by depositing a metal, called filler metal, the filler metal being subjected to a supply of energy so as to become molten and to constitute, upon solidifying, said layer, wherein the filler metal takes the form of a powder , the exposure of which to an energy beam results in a melting followed by a solidification, so as to form a solid layer ,
wherein the part is produced at a temperature from 25 to 150° C.;
wherein the part has a grain structure such that the surface fraction of the equiaxial grains each having an area less than 2.16 µm² is less than 44%, optionally less than 40%, optionally less than 36%; and a grain structure such that the surface fraction of columnar grains is greater than or equal to 22%, optionally
greater than or equal to 25%, optionally greater than or equal to 30%;
and wherein the filler metal is an aluminum alloy comprising at least the following alloy elements:
- Zr, in a mass fraction greater than or equal to 0.30%, optionally 0.30-2.50%, optionally 0.40-2.00%, optionally 0.40-1.80%, optionally 0.50-1.60%, optionally 0.60-1.50%, optionally 0.70-1.40%, optionally 0.80-1.20%;
- Sc, in a mass fraction less than 0.30 %, optionally less than 0.20%, optionally less than 0.10 %, optionally less than 0.05%;
- Mg, in a mass fraction less than 2.00%, optionally less than 1.00%, optionally less than 0.50%, optionally less than 0.30%, optionally less than 0.10%, optionally less than 0.05%;
- Zn, in a mass fraction less than 2.00%, optionally less than 1.00%, optionally less than 0.50%, optionally less than 0.30%, optionally less than 0.10%, optionally less than 0.05%;
- optionally at least one element selected from: Ni, Mn, Cr and/or Cu, in a mass fraction of 0.50 to 7.00%, optionally of 1.00 to 6.00% each; optionally preferably, in a mass fraction less than 25.00%, optionally less than 20.00%, optionally less than 15.00% in total;
- optionally at least one element selected from: Hf, Ti, Er, W, Nb, Ta, Y, Yb, Nd, Ce, Co, Mo, Lu, Tm, V and/or mischmetal, in a mass fraction less than or equal to 5.00%, optionally less than or equal to 3% each, and less than or equal to 15.00%, optionally less than or equal to 12%, optionally less than or equal to 5% in total;
- optionally at least one element selected from: Si, La, Sr, Ba, Sb, Bi, Ca, P, B, In and/or Sn, in a mass fraction less than or equal to 1.00%, optionally less than or equal to 0.5%, optionally less than or equal to 0.3%, optionally less than or equal to 0.1%, optionally less than or equal to 700 ppm each, and less than or equal to 2.00%, optionally less than or equal to 1% in total;
- optionally Fe, in a mass fraction of 0.50 to 7.00%, optionally of 1.00 to 6.00% according to a first alternative embodiment, or in a mass fraction less than or equal to 1.00%, optionally less than or equal to 0.5%, optionally less than or equal to 0.3%, optionally less than or equal to 0.1%, optionally less than or equal to 700 ppm according to a second alternative embodiment;
- optionally at least one element selected from: Ag in a mass fraction of 0.06 to 1.00% and/or Li in a mass fraction of 0.06 to 1.00%;
- optionally impurities in a mass fraction less than 0.05% each optionally 500 ppm, and less than 0.15% in total;
- remainder being aluminum.

2. A method for producing a part, comprising production of successive solid metallic layers, which are superimposed on each other, each layer describing a pattern defined using a digital model , each layer being produced by depositing a metal, called filler metal, the filler metal being subjected to a supply of energy so as to become molten and to constitute, upon solidifying, said layer, wherein the filler metal takes the form of a powder, the exposure of which to an energy beam results in a melting followed by a solidification, so as to form a solid layer,
wherein the part is produced at a temperature from 25 to 150° C.;
wherein the part has a grain structure such that surface fraction of the equiaxial grains each having an area less than 2.16 µm² is less than 44%, optionally less than 40%, optionally less than 36%; and a grain structure such that surface fraction of columnar grains is greater than or equal to 22%, optionally greater than or equal to 25%,
optionally greater than or equal to 30%;
wherein the filler metal is an aluminum alloy comprising at least the following alloy elements:
- Zr and at least one element selected from: Ti, V, Sc, Hf, Er, Tm, Yb and Lu, in a mass fraction greater than or equal to 0.30%, optionally 0.30-2.50%, optionally 0.40-2.00%, optionally 0.40-1.80%, optionally 0.50-1.60%, optionally 0.60-1.50%, optionally 0.70-1.40%, optionally 0.80-1.20% in total, in the knowledge that Zr represents from 10 to less than 100% of the percentage ranges given hereinabove;
- Mg, in a mass fraction less than 2.00%, optionally less than 1.00%, optionally less than 0.50%, optionally less than 0.30%, optionally less than 0.10%, optionally less than 0.05%;
- Zn, in a mass fraction less than 2.00%, optionally less than 1.00%, optionally less than 0.50%, optionally less than 0.30%, optionally less than 0.10%, optionally less than 0.05%;
- optionally at least one element selected from: Ni, Mn, Cr and/or Cu, in a mass fraction of 0.50 to 7.00%, optionally of 1.00 to 6.00% each; optionally preferably, in a mass fraction less than 25.00%, optionally less than 20.00%, optionally less than 15.00% in total;
- optionally at least one element selected from: W, Nb, Ta, Y, Nd, Ce, Co, Mo and/or mischmetal, in a mass fraction less than or equal to 5.00%, optionally less than or equal to 3% each, and less than or equal to 15.00%, optionally less than or equal to 12 %, optionally less than or equal to 5% in total;
- optionally at least one element selected from: Si, La, Sr, Ba, Sb, Bi, Ca, P, B, In and/or Sn, in a mass fraction less than or equal to 1.00%, optionally less than or equal to 0.5%, optionally less than or equal to 0.3%, optionally than or equal to 0.1%, optionally less than or equal to 700 ppm each, and less than or equal to 2.00%, optionally less than or equal to 1% in total;
- optionally Fe, in a mass fraction of 0.50 to 7.00%, optionally of 1.00 to 6.00% according to a first alternative embodiment, or in a mass fraction less than or equal to 1.00%, optionally less than or equal to 0.5%, optionally less than or equal to 0.3%, optionally less than or equal to 0.1%, optionally less than or equal to 700 ppm according to a second alternative embodiment;
- optionally at least one element selected from: Ag in a mass fraction of 0.06 to 1.00% and/or Li in a mass fraction of 0.06 to 1.00%;
- optionally impurities in a mass fraction less than 0.05% each optionally 500 ppm, and less than 0.15% in total;
- remainder being aluminum.

3. The method according to claim 1 , wherein the part is produced at a temperature optionally from 50 to 130° C., optionally from 50 to 110° C., optionally from 80 to 110° C., optionally from 80 to 105° C.

4. A method for producing a part comprising production of successive solid metallic layers, which are superimposed on each other, each layer describing a pattern defined using a digital model , each layer being produced by depositing a metal, called filler metal, the filler metal being subjected to a supply of energy so as to become molten and to constitute, upon solidifying, said layer, wherein the filler metal takes the form of a powder, the exposure of which to an energy beam results in a melting followed by a solidification, so as to form a solid layer,
wherein the filler metal is an aluminum alloy comprising at least the following alloy elements:
- Zr, in a mass fraction greater than or equal to 0.30%, optionally 0.30-2.50%, optionally 0.40-2.00%, optionally 0.40-1.80%, optionally 0.50-1.60%, optionally 0.60-1.50%, optionally 0.70-1.40%, optionally 0.80-1.20%;
- Sc, in a mass fraction less than 0.30 %, optionally less than 0.20%, optionally less than 0.10 %, optionally less than 0.05%;
- Mg, in a mass fraction less than 2.00%, optionally less than 1.00%, optionally less than 0.50%, optionally less than 0.30%, optionally less than 0.10%, optionally less than 0.05%;
- Zn, in a mass fraction less than 2.00%, optionally less than 1.00%, optionally less than 0.50%, optionally less than 0.30%, optionally less than 0.10%, optionally less than 0.05%;
- optionally at least one element selected from: Ni, Mn, Cr and/or Cu, in a mass fraction of 0.50 to 7.00%, optionally of 1.00 to 6.00% each; optionally preferably, in a mass fraction less than 25.00%, optionally less than 20.00%, optionally less than 15.00% in total;
- optionally at least one element selected from: Hf, Ti, Er, W, Nb, Ta, Y, Yb, Nd, Ce, Co, Mo, Lu, Tm, V and/or mischmetal, in a mass fraction less than or equal to 5.00%, optionally less than or equal to 3% each, and less than or equal to 15.00%, optionally less than or equal to 12%, optionally less than or equal to 5% in total;
- optionally at least one element selected from: Si, La, Sr, Ba, Sb, Bi, Ca, P, B, In and/or Sn, in a mass fraction less than or equal to 1.00%, optionally less than or equal to 0.5%, optionally less than or equal to 0.3%, optionally less than or equal to 0.1%, optionally less than or equal to 700 ppm each, and less than or equal to 2.00%, optionally less than or equal to 1% in total;
- optionally Fe, in a mass fraction of 0.50 to 7.00%, optionally of 1.00 to 6.00% according to a first alternative embodiment, or in a mass fraction less than or equal to 1.00%, optionally less than or equal to 0.5%, optionally less than or equal to 0.3%, optionally less than or equal to 0.1%, optionally less than or equal to 700 ppm according to a second alternative embodiment;
- optionally at least one element selected from: Ag in a mass fraction of 0.06 to 1.00% and/or Li in a mass fraction of 0.06 to 1.00%;
- optionally impurities in a mass fraction less than 0.05% each optionally 500 ppm, and less than 0.15% in total;
- remainder being aluminum;
wherein the part is produced at a temperature from more than 250 to less than 350° C., optionally from 280 to 330° C.

5. A method for producing a part comprising the production of successive solid metallic layers, which are superimposed on each other, each layer describing a pattern defined using a digital model , each layer being produced by depositing a metal, called filler metal, the filler metal being subjected to a supply of energy so as to become molten and to constitute, upon solidifying, said layer, wherein the filler metal takes the form of a powder, the exposure of which to an energy beam results in a melting followed by a solidification, so as to form a solid layer,
wherein the filler metal is an aluminum alloy comprising at least the following alloy elements:
- Zr and at least one element selected from: Ti, V, Sc, Hf, Er, Tm, Yb and Lu, in a mass fraction greater than or equal to 0.30%, optionally 0.30-2.50%, optionally 0.40-2.00 %, optionally 0.40-1.80%, optionally 0.50-1.60%, optionally 0.60-1.50%, optionally 0.70-1.40%, optionally 0.80-1.20% in total, in the knowledge that Zr represents from 10 to less than 100% of the percentage ranges given hereinabove;
- Mg, in a mass fraction less than 2.00%, optionally less than 1.00%, optionally less than 0.50%, optionally less than 0.30%, optionally less than 0.10%, optionally less than 0.05%;
- Zn, in a mass fraction less than 2.00%, optionally less than 1.00%, optionally less than 0.50%, optionally less than 0.30%, optionally less than 0.10%, optionally less than 0.05%;
- optionally at least one element selected from: Ni, Mn, Cr and/or Cu, in a mass fraction of 0.50 to 7.00%, optionally of 1.00 to 6.00% each; optionally preferably, in a mass fraction less than 25.00%, optionally less than 20.00%, optionally less than 15.00% in total;
- optionally at least one element selected from: W, Nb, Ta, Y, Nd, Ce, Co, Mo and/or mischmetal, in a mass fraction less than or equal to 5.00%, optionally less than or equal to 3% each, and less than or equal to 15.00%, optionally less than or equal to 12%, optionally less than or equal to 5% in total;
- optionally at least one element selected from: Si, La, Sr, Ba, Sb, Bi, Ca, P, B, In and/or Sn, in a mass fraction less than or equal to 1.00%, optionally less than or equal to 0.5%, optionally less than or equal to 0.3%, optionally less than or equal to 0.1%, optionally less than or equal to 700 ppm each, and less than or equal to 2.00%, optionally less than or equal to 1% in total;
- optionally Fe, in a mass fraction of 0.50 to 7.00%, optionally of 1.00 to 6.00% according to a first alternative embodiment, or in a mass fraction less than or equal to 1.00%, optionally less than or equal to 0.5%, optionally less than or equal to 0.3%, optionally less than or equal to 0.1%, optionally less than or equal to 700 ppm according to a second alternative embodiment;
- optionally at least one element selected from: Ag in a mass fraction of 0.06 to 1.00% and/or Li in a mass fraction of 0.06 to 1.00%;
- optionally impurities in a mass fraction less than 0.05% each optionally 500 ppm, and less than 0.15% in total;
- remainder being aluminum;
wherein the part is produced at a temperature from more than 250 to less than 350° C., optionally from 280 to 330° C.

6. The method according to claim 1 , wherein the aluminum alloy comprises:
- Zr, in a mass fraction of 0.50 to 3.00%, optionally of 0.50 to 2.50%, optionally of 0.60 to 1.40%, optionally of 0.70 to 1.30%, optionally of 0.80 to 1.20%, optionally of 0.85 to 1.15%; optionally of 0.90 to 1.10%;
- Mn, in a mass fraction of 1.00 to 7.00%, optionally of 1.00 to 6.00%, optionally of 2.00 to 5.00%; optionally of 3.00 to 5.00%, optionally of 3.50 to 4.50%;
- Ni, in a mass fraction of 1.00 to 6.00%, optionally of 1.00 to 5.00%, optionally of 2.00 to 4.00%, optionally of 2.50 to 3.50%;
- optionally Fe, in a mass fraction less than or equal to 1.00%, optionally less than or equal to 0.50%, optionally less than or equal to 0.30%; and optionally greater than or equal to 0.05, optionally greater than or equal to 0.10%;
- optionally Si, in a mass fraction less than or equal to 1.00%, optionally less than or equal to 0.50%;
- optionally Cu, in a mass fraction of 1.00 to 5.00%, optionally of 1.00 to 3.00%, optionally of 1.50 to 2.50%.

7. The method according to claim 1 , including, following the formation of the layers,
- a thermal treatment optionally at a temperature of at least 100° C. and at most 500° C., optionally from 300 to 450° C.; and/or,
- a hot isostatic compression.

8. The method according to claim 1 , wherein addition of La, Bi, Mg, Er, Yb, Y, Sc and/or Zn is avoided, optional mass fraction of each of these elements then being less than 0.05%, and optionally less than 0.01%.

9. The method according to claim 1 , wherein the aluminum alloy also comprises at least one element to refine grains, optionally AlTiC or AlTiB2, according to a quantity less than or equal to 50 kg/ton, optionally less than or equal to 20 kg/ton, optionally less than or equal to 12 kg/ton each, and less than or equal to 50 kg/ton, optionally less than or equal to 20 kg/ton in total.

10. A metallic part obtained with a method according to claim 1, comprising a grain structure such that surface fraction of equiaxial grains each having an area less than 2.16 µm² is less than 44%, optionally less than 40%, optionally less than 36%; and such that surface fraction of columnar grains is greater than or equal to 22%, optionally preferably greater than or equal to 25%, optionally greater than or equal to 30%.

11. A powder comprising an aluminum alloy which comprises at least the following alloy elements:
- Zr, in a mass fraction of 0.30-1.40 %, optionally preferably 0.40-1.40%, optionally 0.50-1.40%, optionally 0.60-1.40%, optionally 0.70-1.40%, optionally 0.80-1.20%;
- Sc, in a mass fraction less than 0.30%, optionally preferably less than 0.20%, optionally preferably less than 0.10%, optionally preferably less than 0.05%;
- Mg, in a mass fraction less than 2.00%, optionally less than 1.00%, optionally preferably less than 0.50%, optionally less than 0.30%, optionally less than 0.10%, optionally less than 0.05%;
- Zn, in a mass fraction less than 2.00%, optionally preferably less than 1.00%, optionally preferably less than 0.50%, optionally less than 0.30%, optionally less than 0.1%, optionally less than 0.05%;
- optionally at least one element selected from: Ni, Mn, Cr and/or Cu, in a mass fraction of 0.50 to 7.00%, optionally preferably of 1.00 to 6.00% each; optionally preferably, in a mass fraction less than 25.00%, optionally preferably less than 20.00%, optionally less than 15.00% in total;
- optionally at least one element selected from: Hf, Ti, Er, W, Nb, Ta, Y, Yb, Nd, Ce, Co, Mo, Lu, Tm, V and/or mischmetal, in a mass fraction less than or equal to 5.00%, optionally preferably less than or equal to 3% each, and less than or equal to 15.00%, optionally preferably less than or equal to 12%, optionally less than or equal to 5% in total;
- optionally at least one element selected from: Si, La, Sr, Ba, Sb, Bi, Ca, P, B, In and/or Sn, in a mass fraction less than or equal to 1.00%, optionally preferably less than or equal to 0.5%, optionally preferably less than or equal to 0.3%, optionally preferably less than or equal to 0.1%, optionally less than or equal to 700 ppm each, and less than or equal to 2.00%, optionally preferably less than or equal to 1% in total;
- optionally Fe, in a mass fraction of 0.50 to 7.00%, optionally preferably of 1.00 to 6.00% according to a first alternative embodiment, or in a mass fraction less than or equal to 1.00%, optionally preferably less than or equal to 0.5%, optionally preferably less than or equal to 0.3%, optionally less than or equal to 0.1%, optionally less than or equal to 700 ppm according to a second alternative embodiment;
- optionally at least one element selected from: Ag in a mass fraction of 0.06 to 1.00% and/or Li in a mass fraction of 0.06 to 1.00%;
- optionally impurities in a mass fraction less than 0.05% each optionally 500 ppm and less than 0.15% in total;
- remainder being aluminum.

12. A powder comprising an aluminum alloy which comprises at least the following alloy elements:
- Zr and at least one element selected from: Ti, V, Sc, Hf, Er, Tm, Yb and Lu, in a mass fraction of 0.30-1.40%, optionally preferably of 0.40-1.40%, optionally preferably of 0.50-1.40%, optionally of 0.600-1.4%, optionally of 0.70-1.40%, optionally of 0.80-1.20% in total, in the knowledge that Zr represents from 10 to less than 100% of the percentage ranges given hereinabove;
- Mg, in a mass fraction less than 2.00%, optionally preferably less than 1.00%, optionally preferably less than 0.50%, optionally less than 0.30%, optionally less than 0.10%, optionally less than 0.05%;
- Zn, in a mass fraction less than 2.00%, optionally preferably less than 1.00%, optionally preferably less than 0.50%, optionally less than 0.30%, optionally less than 0.10%, optionally less than 0.05%;
- optionally at least one element selected from: Ni, Mn, Cr and/or Cu, in a mass fraction of 0.50 to 7.00%, optionally preferably of 1.00 to 6.00% each; optionally preferably, in a mass fraction less than 25.00%, optionally less than 20.00%, optionally less than 15.00% in total;
- optionally at least one element selected from: W, Nb, Ta, Y, Nd, Ce, Co, Mo and/or mischmetal, in a mass fraction less than or equal to 5.00%, optionally preferably less than or equal to 3% each, and less than or equal to 15.00%, optionally preferably less than or equal to 12%, optionally less than or equal to 5% in total;
- optionally at least one element selected from: Si, La, Sr, Ba, Sb, Bi, Ca, P, B, In and/or Sn, in a mass fraction less than or equal to 1.00%, optionally preferably less than or equal to 0.5%, optionally preferably less than or equal to 0.3%, optionally preferably less than or equal to 0.1%, optionally preferably less than or equal to 700 ppm each, and less than or equal to 2.00%, optionally preferably less than or equal to 1% in total;
- optionally Fe, in a mass fraction of 0.50 to 7.00%, optionally preferably of 1.00 to 6.00% according to a first alternative embodiment, or in a mass fraction less than or equal to 1.00%, optionally preferably less than or equal to 0.5%, optionally preferably less than or equal to 0.3%, optionally less than or equal to 0.1%, optionally less than or equal to 700 ppm according to a second alternative embodiment;
- optionally at least one element selected from: Ag in a mass fraction of 0.06 to 1.00% and/or Li in a mass fraction of 0.06 to 1.00%;
- optionally impurities in a mass fraction less than 0.05% each optionally 500 ppm and less than 0.15% in total;
- remainder being aluminum.
